(19) United States
(12) Patent Application Publication
(10) Pub. No.: US 2011/0281470 A1
(43) Pub. Date: Nov. 17, 2011

(54) CABLE ASSEMBLY WITH IMPROVED TERMINATING MEANS

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/105,940

(22) Filed: May 12, 2011

(30) Foreign Application Priority Data
May 12, 2010 (CN) 201020187758.8

(51) Int. Cl. H01R 24/00

(52) U.S. Cl. 439/660

(57) ABSTRACT

A cable assembly (1000) includes an insulative housing (11); a plurality of contacts (131, 132) mounted to the insulative housing, and each of the contacts having a retention portion, a mating portion and a tail portion; a cable (14) having an insulative jacket (141) and a plurality of wires (142, 143) enclosed by the insulative jacket, and the tail portion of each contact axially penetrating into a corresponding wire; and a metallic shielding member (152) enclosing an interconnecting area between the contacts and the wires, the metallic shielding member having an connecting portion (1522) mounted to the cable, and the connecting portion (1522) defining a plurality of teeth (1523) respectively engaged with positioning cavities on the insulative jacket.

### BACKGROUND OF THE INVENTION

1. Field of the invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a plurality of contacts mounted to the insulative housing, and each of the contacts having a retention portion, a mating portion and a tail portion; a cable having an insulative jacket and a plurality of wires enclosed by the insulative jacket, and the tail portion of each contact axially penetrating into a corresponding wire; and a metallic shielding member enclosing an interconnecting area between the contacts and the wires, the metallic shielding member having an connecting portion mounted to the cable, and the connecting portion defining a plurality of teeth respectively engaged with positioning cavities on the insulative jacket.

The detailed features of the present invention will be apparent in the detailed description with appropriate reference to the accompanying drawings.

### BRIEF DESCRIPTION OF THE DRAWINGS

FIG. 1 is an assembled, perspective view of a cable assembly in accordance with the present invention;

FIG. 2 is an exploded, perspective view of the cable assembly in FIG. 1;

FIG. 3 is similar to FIG. 2, but viewed from other aspect;

FIG. 4 is a partial assembled perspective view of the cable assembly; and

FIG. 5 is a cross-section view of the FIG. 1 taken along a line 5-5.

### DETAILED DESCRIPTION OF THE INVENTION

Reference will now be made in detail to the preferred embodiment of the present invention.

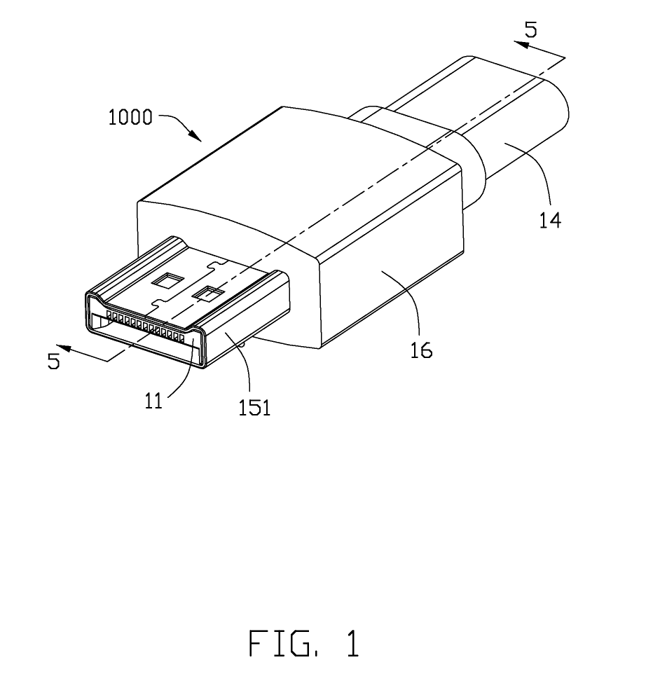

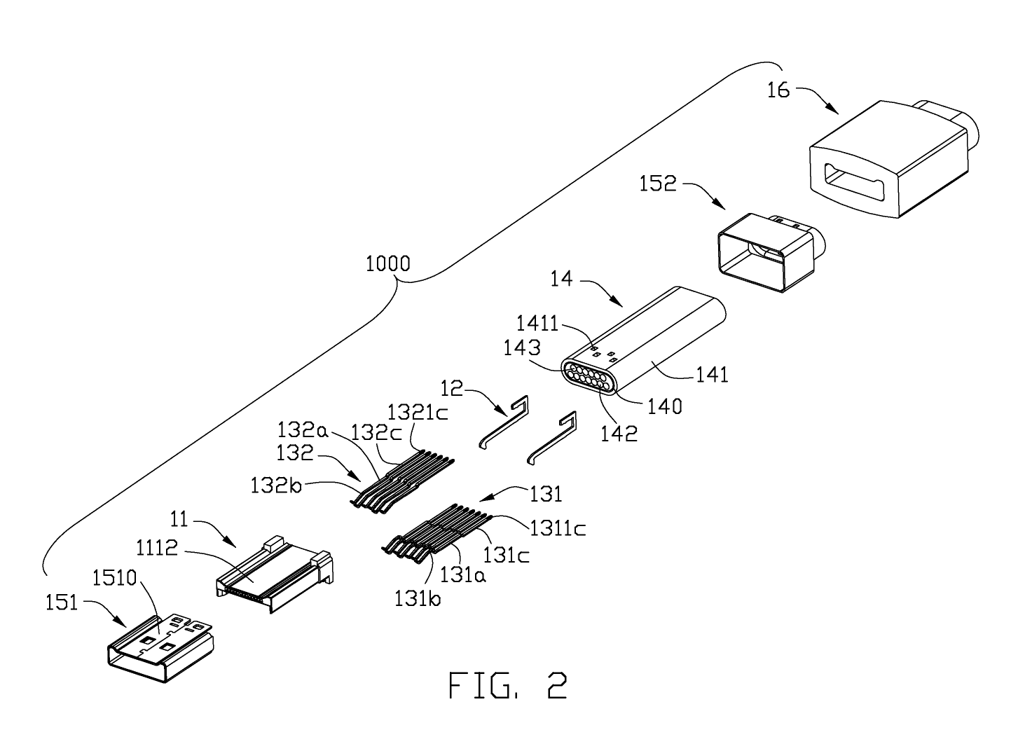

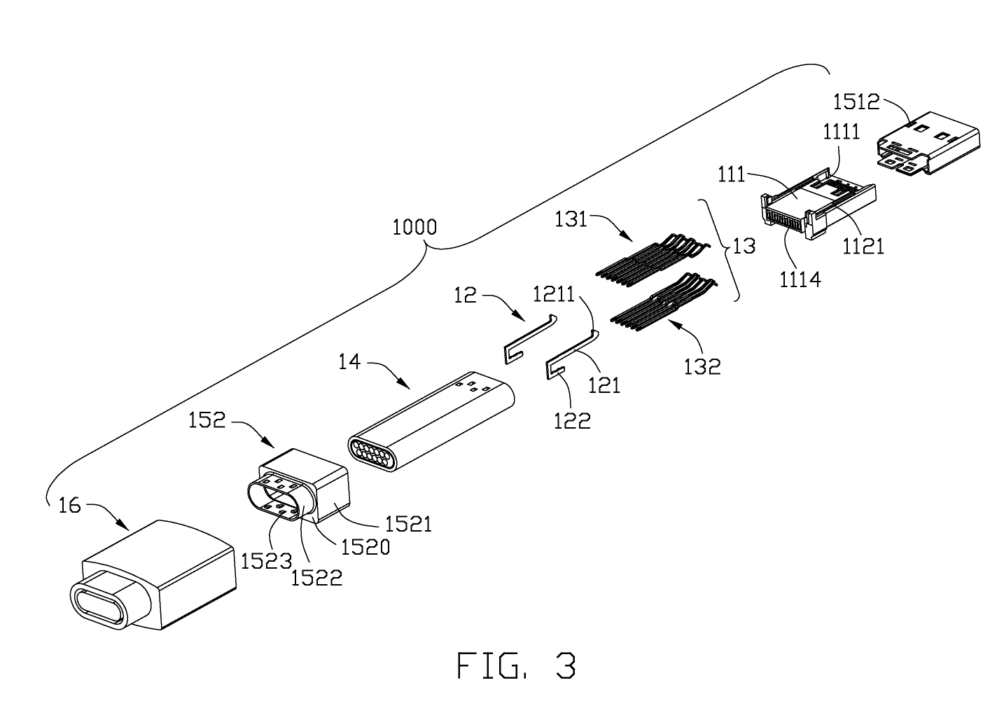

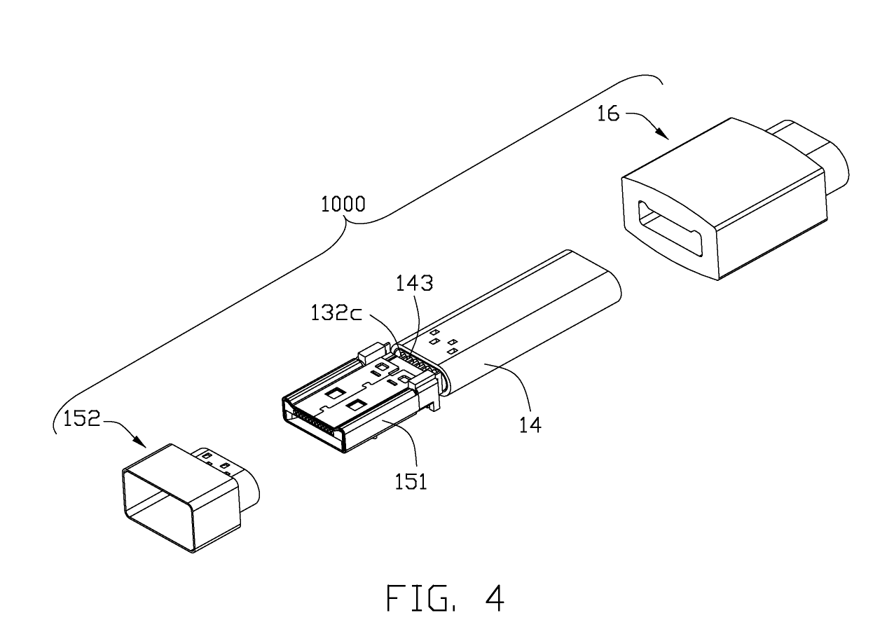

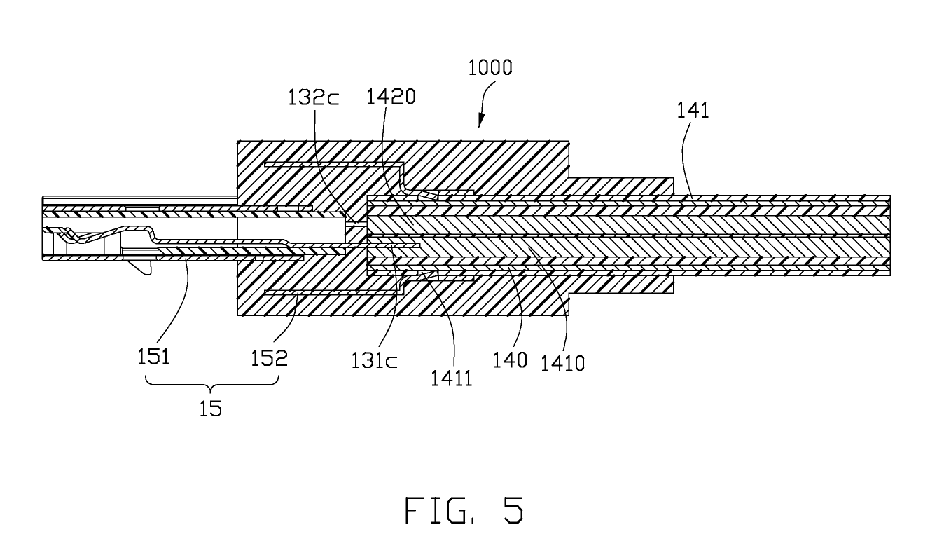

Referring to FIGS. 1-5, a cable assembly 1000 in accordance with the present invention comprises an insulative housing 11, a pair of latching members 12, a plurality of contacts 13, a cable 14, a metallic shielding member 15 and an insulative cover 16.

The insulative housing 11 has a base portion 111 with a mating port 1111 located in a front segment of the base portion 111 and further communicates with an exterior vertically. There are a plurality of contact slots 1114 recessed forwardly from a back edge of the base portion 111. The contacts slots 1114 further communicates with the mating port 1111. There is a depression 1112 located on a bottom side of the insulative housing 11.

Each latching member 12 has a latching arm 121 extending along a longitudinal direction and a L-shaped retention portion 122 connected to an end of the latching arm 121. The retention portion 122 is located under the latching arm 121. In addition, there is a hooking portion 1211 formed on a front end of the latching arm 121 and the hooking portion 1211 projects upwardly therefrom.

The contacts 13 are separated a set of first contacts 131 and a set of second contacts 132. The set of first contacts 131 and the set of second contacts 132 are spaced apart from each other along a vertical direction. Each first contact 131 has a retention portion 131a, a mating portion 131b extending forwardly from the retention portion 131a and a tail portion 131c extending backwardly from the retention portion 131a. The tail portion 131c further has a tapered/sharp end 1311c. Each second contact 132 has a retention portion 132a, a mating portion 132b extending forwardly from the retention portion 132a and a tail portion 132c extending backwardly from the retention portion 132a. The tail portion 132c further has a tapered/sharp end 1321c.

The first contacts 131 and the second contacts 132 are mounted to the insulative housing 11, with the retention portions 131a, 132a received in the contact slots 1114, the mating portions 131b, 132b located in the mating port 1111, and the tail portions 131c, 132c disposed beyond the back edge of the base portion 111 and separated into two transversal groups spaced apart from each other along the vertical direction.

The cable assembly 1000 is compatible with Digital Interactive Interface for Video & Audio (DiiVA) transmitting protocol. The cable assembly 1000 includes seven of the first contacts 131 and six of the second contacts 132. The mating portions 131b of the first contacts 131 and the mating portions 132b of the second contacts 132 are disposed in one row along the transversal direction, and the mating portions 131b and the mating portions 132b are spaced apart from each other. There are eight signal contacts and five grounding contacts of total thirteen contacts. The eight signal contacts are divided into three pairs of differential pairs and other pair of signal contacts. The three pairs of differential pairs are spaced apart from each other by a grounding contact.

The cable 14 is a flat type cable. The cable 14 includes a group of first wires 142 and a group of second wires 143 separated from each other along a vertical direction, a metallic braiding member 140 enclosing the first wires 142 and the second wires 143 and an insulative jacket 141 shielding the metallic braiding member 140. The group of first wires 142 and the group of second wires 143 are respectively disposed in one row along the transversal direction.

The first wires 142 and the second wires 143 respectively align with the tail portions 131c, 132c of the first contacts 131 and the second contacts 132, with the tail portions 131c, 132c axially penetrated/inserted into the first wires 142 and the second wires 143 and further contacting with inner conductors 1410, 1420 thereof axially. Thus, the tail portions 131c, 132c can electrically connect with the first wires 142 and the second wires 143.

The metallic shielding member 15 includes a first metallic shielding member 151 and a second metallic shielding member 152. Both the first metallic shielding member 151 and the second metallic shielding member 152 assembled to a front segment and a back segment of the insulative housing only along an axially direction or a front-to-back direction.

The first metallic shielding member 151 is a frame structure and encloses the insulative housing 11. There is a concave 1510 located at a bottom side of the first metallic shielding member 151. The concave 1510 is received in the depression 1112 of the insulative housing 11.

The second metallic shielding member 152 has a main portion 1521 with a front opening and a back side 1520, a connection portion 1522 projecting backwardly from the back side 1520. The main portion 1521 is of rectangular shape which encloses/shields an interconnecting area between the contacts and the wires; and the connecting portion 1522 is an ellipse structure and mounted to the cable 14 along an axially direction. The connecting portion 1522 has a plurality of teeth 1523 extending inwardly therefrom. There are four sets of teeth 1523 extending into interior side of the connecting portion 1522. The four sets of teeth 1523 are divided into two distinct sets and respectively arranged on a top and bottom inner surfaces of the connecting portion 1522. Therefore, there are two sets of teeth 1523 formed on either the top and the bottom inner surfaces of the connecting portion 1522. In addition, the two sets of teeth 1523 are disposed in a staggered manner and offset from each other along the axial direction.

The connecting portion 1522 is mounted to the cable 14, with the teeth 1523 respectively engaged with corresponding positioning cavities 1411 which are defined on the insulative jacket 141. The teeth 1523 further contact with the metallic shielding member 140 to form a grounding path between the metallic shielding member 15 and the cable 14.

The insulative cover 16 is attached to a back segment of the first metallic shielding member 151, the second metallic shielding member 152 and a portion of the cable 14 adjacent to the second metallic shielding member 152.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a plurality of contacts mounted to the insulative housing, and each of the contacts having a retention portion, a mating portion and a tail portion;
a cable having an insulative jacket and a plurality of wires enclosed by the insulative jacket, and the tail portion of each contact axially penetrating into a corresponding wire; and
a metallic shielding member enclosing an interconnecting area between the contacts and the wires, the metallic shielding member having an connecting portion mounted to the cable, and the connecting portion defining a plurality of teeth respectively engaged with positioning cavities on the insulative jacket.

2. The cable assembly as claimed in claim 1, wherein the teeth are formed on a top side and a bottom side of the connecting portion.

3. The cable assembly as claimed in claim 2, wherein there are teeth of either the top side or the bottom side of the connecting portion are divided into two sets.

4. The cable assembly as claimed in claim 3, wherein the teeth of either the top side or the bottom side of the connecting portion are disposed in staggered manner.

5. The cable assembly as claimed in claim 1, wherein the cable further has metallic braiding member enclosing the wires and shielded by the insulative jacket.

6. The cable assembly as claimed in claim 5, wherein the teeth contact with the metallic braiding member.

7. The cable assembly as claimed in claim 1, wherein the tail portion has a tapered end.

8. The cable assembly as claimed in claim 1, wherein the insulative housing defines a mating port located in a front segment of the thereof and the mating port communicates with an exterior vertically, and the mating portions of the contacts are accommodated in the mating port.

9. The cable assembly as claimed in claim 8, wherein there are a plurality of contact slots recessed forwardly from a back edge of the insulative housing and communicating with the mating port, and the retention portions of the contacts are received in the contact slots, respectively.

10. The cable assembly as claimed in claim 8, wherein the tail portions of the contacts are disposed beyond a back edge of the insulative housing, and the tail portions are separated into two transversal groups and spaced apart from each other along a vertical direction.

11. The cable assembly as claimed in claim 10, wherein the cable is a flat type cable and the wires thereof are separated into two groups aligning with the two groups of the tail portions, respectively.

12. The cable assembly as claimed in claim 1, wherein the metallic shielding member includes a first metallic shielding member and a second metallic shielding member.

13. The cable assembly as claimed in claim 12, wherein the first metallic shielding member is assembled to the insulative housing only along an axial direction.

14. The cable assembly as claimed in claim 13, wherein the second metallic shielding member is assembled to the insulative housing only along the axial direction.

15. The cable assembly as claimed in claim 14, wherein there is an insulative cover attached to the first metallic shielding member, a second metallic shielding member and portion of the cable.

16. A cable connector assembly comprising:
an insulative housing defining a front mating port and a rear mounting port;
a plurality of contacts disposed in the housing, each of said contacts defining a front contacting section located in the mating port, and rear tail section located around the mounting port;
a cable including an insulative jacket enclosing a plurality of wires, the tail sections of said contacts axially inserted into the corresponding wires, respectively;
a metallic shell enclosing an interconnection portion between the contacts and the wires, said shell including a tubular connection section snugly receiving a front portion of the cable and equipped with a plurality of teeth each inwardly pressing the cable essentially in a radial direction perpendicular to said axial direction.

17. The cable connector assembly as claimed in claim 16, wherein said jacket forms with a plurality of positioning cavities to receive the corresponding tooth.

18. The cable connector assembly as claimed in claim 16, further including an insulative cover enclosing the shell.
